(19) United States
(12) Patent Application Publication
(10) Pub. No.: US 2013/0173427 A1
(43) Pub. Date: Jul. 4, 2013

(54) APPARATUS AND METHOD OF DATA SHARING BETWEEN ONLINE MARKETPLACES

(71) Applicants: Colin E. SWINDELLS, Victoria (CA); Jord TANNER, Victoria (CA); Andrew E. R. SUKOW, Victoria (CA); Anthony E. R. SUKOW, Victoria (CA); Maximilian O. KLESS, Victoria (CA); Patrick LYNAM, Victoria (CA)

(72) Inventors: Colin E. SWINDELLS, Victoria (CA); Jord TANNER, Victoria (CA); Andrew E. R. SUKOW, Victoria (CA); Anthony E. R. SUKOW, Victoria (CA); Maximilian O. KLESS, Victoria (CA); Patrick LYNAM, Victoria (CA)

(73) Assignee: ADVANCED E-COMMERCE RESEARCH SYSTEMS, INC., Victoria (CA)

(21) Appl. No.: 13/342,855

(22) Filed: Jan. 3, 2012

(51) Int. Cl. G06Q 30/00

(52) U.S. Cl. 705/26.61

(57) ABSTRACT

A method of sharing data including receiving, at a server, first data associated with a first marketplace and second data associated with a second marketplace, storing the first data and the second data in a memory of the server, determining attributes of the first data, the attributes comprising at least one data type, generating filtered second data, the filtered second data being a subset of the second data limited to the at least one data type, wherein the filtered second data is for sending to the first marketplace in response to the first data being received at the server.

### TECHNICAL FIELD

The present application relates to data sharing for online buying and selling of goods and services.

### BACKGROUND DISCUSSION

In recent years, marketplaces that facilitate online transactions of goods and services have become increasingly popular. Marketplace research tools store data related to one or more marketplaces. The data may include Ecommerce transaction prices, quantities, and item descriptions, for example. Other data including demographics, weather, and news feeds, for example, which has been shown to influence buying and selling strategies, may also be stored. Marketplace research tools provide data and analytics to online users looking to inform their buying and selling strategies. Online users include consumers, merchants, and off-price specialists who may be motivated to share data. Because users rely on online marketplaces to buy and sell items, and online marketplaces rely on users, a mutually advantageous relationship is possible where online users and marketplaces share data in order to enhance the effectiveness of an online marketplace, and increase prosperity of all participating users.

Access to marketplace research data is often administered with associations to objects (access control lists) or subjects (user or role capabilities). Access administration methods typically operate on the concept of each user being permitted or not permitted access to particular data.

### SUMMARY

There is provided herein a sharing method including set of rules for one or more marketplaces that define how data sharing occurs between marketplaces. Data transfers for a marketplace are restricted based on what data that marketplace, and other marketplaces, have transferred for sharing. Data transfers from multiple marketplaces are accepted into a data storage that flags data fields for sharing with other marketplaces. Data transfer requests from multiple marketplaces are either accepted or denied based on the marketplace's data sharing activities with other marketplaces. In general, a marketplace will be permitted access to similar amounts and types of Ecommerce transactional data from other marketplaces that it has made available for sharing with those other marketplaces.

In an aspect there is provided a method of sharing data, including: receiving, at a server, first data associated with a first marketplace and second data associated with a second marketplace, storing the first data and the second data in a memory of the server, determining attributes of the first data, the attributes comprising at least one data type, generating filtered second data, the filtered second data being a subset of the second data limited to the at least one data type, and wherein the filtered second data is for sending to the first marketplace in response to the first data being received at the server.

In another aspect there is provided, a system of sharing data, comprising: a first online marketplace; a second online marketplace; and a data and analysis system comprising a server receiving first data from the first online marketplace and second data from the second online marketplace, determining attributes of the first data, the attributes comprising at least one data type and generating filtered second data, the filtered second data being a subset of the second data limited to the at least one data type, and sending the filtered second data to the first online marketplace in response to the first data being received at the server.

Other aspects and features of the present disclosure will become apparent to those ordinarily skilled in the art upon review of the following description of specific embodiments in conjunction with the accompanying figures.

### BRIEF DESCRIPTION OF THE DRAWINGS

Embodiments of the present application will now be described, by way of example only, with reference to the attached Figures, wherein:

FIG. 1 is a schematic block diagram depicting an apparatus for sharing data between marketplaces;

FIG. 2 is a schematic block diagram depicting data flow between marketplaces and a data storage and analysis system;

FIG. 3 is a flowchart illustrating a method of sharing data between marketplaces;

FIG. 4 is a schematic block diagram depicting data flow between marketplaces and a structured data storage according to the method of FIG. 3;

FIG. 5 is schematic diagram of data sharing rules for marketplace data;

FIG. 6 is an example of a user interface for an online marketplace;

FIG. 7 is an example of another user interface for an online marketplace;

FIG. 8 is a flowchart illustrating a method of updating a marketplace;

FIG. 9 is flowchart illustrating a method of updating the sharing configurations of a marketplace;

FIG. 10 is a flowchart illustrating a method of managing requested data by a marketplace; and

FIG. 11 is a flowchart illustrating a method managing sent data to a marketplace.

### DETAILED DESCRIPTION

It will be appreciated that numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein.

Also, the description is not to be considered as limiting the scope of the embodiments described herein.

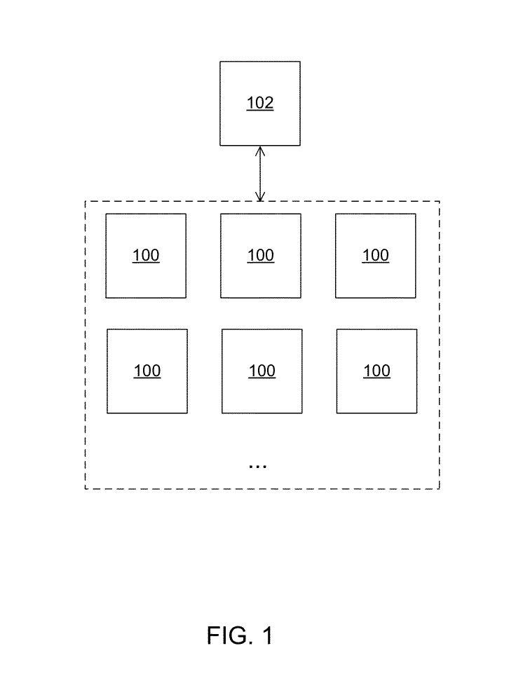

Referring to FIG. 1, one or more marketplaces 100 communicate with a data storage and analysis system 102 via the Internet. Examples of marketplaces 100 include eBay, Amazon, Yahoo! Japan, and PriceMinister. Marketplaces 100 are online stores through which items such as good and services may be bought and/or sold. Marketplaces 100 may be any size and may be capable of facilitating any transaction volume.

The data storage and analysis system 102 includes a server having at least one processor, a Random Access Memory (RAM) and a non-volatile memory, such as flash memory, for example. The data storage and analysis system 102 further includes a communication subsystem in communication with a network to send and receive data. The data storage and analysis system 102 may be provided on a single server or may be provided on multiple servers.

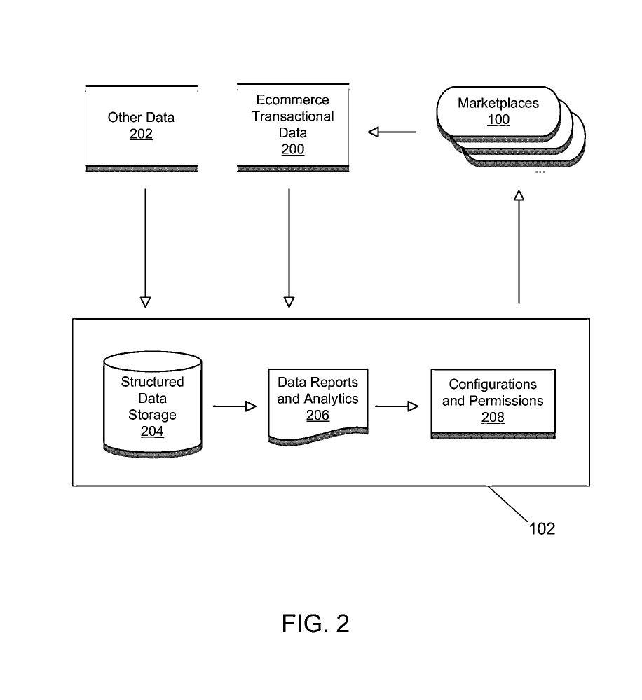

Referring also to FIG. 2, marketplaces 100 may share some or all of their Ecommerce transactional data 200 with the data storage and analysis system 102 of a data service provider. The Ecommerce transactional data 200 includes prices and quantities of goods and services sold at marketplaces, for example. The Ecommerce transactional data 200 is stored in a structured data storage 204 in memory of the data storage and analysis system 102. Ecommerce transactional data 200 may be associated with meta data 202 which is also stored in the data storage system 204. Other data includes data that may influence buyer or seller behaviors, such as weather or political events, for example. Other data may originate from marketplaces, users, third parties or intermediate solutions providers, for example. Marketplaces 100 may receive reports and analytics relating to data that is stored in the structured data storage 204. Data reports and analytics 206 may then be downloaded by marketplaces according a method of sharing data, which defines data access configurations and permissions 208 that are associated with each marketplace 100.

In the structured data storage 204, data is stored in association with data fields and one or more data fields may be shared between marketplaces 100. In one embodiment, data representations including groups of data fields are shared between marketplaces 100. Some example data representations are shown in the following tables, however, other data representations are also possible.

Table I includes data fields associated with an item for sale on an Ecommerce marketplace such as price, description, unique identification number, condition, time placed for sale and time sold, for example. Items may represent goods or services and the data fields include auction or fixed price sales.

TABLE I

| Field | Description |
|---|---|
| Basket_id | The unique marketplace specific collection of |
| | transactions id for the collection of goods or |
| | services |
| Listing_id | The unique marketplace specific listing id for the |
| | good or service (purchase or refund) |
| Product_id | Type of Product ID such as “EPID”, “ASIN”, or |
| | “JAN” for eBay, Amazon, or Yahoo! Japan IDs |
| | respectively. |
| Buyer_id | Marketplace defined unique id of the Buyer. |
| Product_description | Manufacturer's description of the Product. |
| Product_title | Listing title as entered by the seller. |
| Product_subtitle | Listing subtitle as entered by the seller. |
| Product_condition | Numeric identifier for an Product's condition such |
| | as new, used, or refurbished. |
| Date_start | The start date and time of the auction or fixed price |
| Date_end | The end date and time of the auction or fixed price |
| Leaf_categ_id | The category id associated with the Product. |
| List_price_usd | Manufacturer's list price. |
| Sold_price_usd | Gross item sold price. |

Table II includes data fields associated with hierarchical item categories. An example traversal down a three-level item category tree may be (i) “Clothing, Shoes, & Accessories”, (ii) “Women's Shoes”, (iii) “Athletic” in which “Athletic” and “Women's Shoes” may represent the “Category” and “Category Parent” data fields of Table II. Further, example ID name (“ID_name”) and ID value (“ID_value”) pairs may include {“US Shoe Size”, “7”}, {“Condition”, “New”}, and {“Color”, “Black”}.

TABLE II

| Field | Description |
|---|---|
| Listing_id | A unique ID for the listing |
| Category | Unique identifier for a marketplace generic |
| | category name |
| Category_parent | Parent node to the category market-place |
| | generic category name |
| ID_name | Description of the sub-field (e.g., ISBN, |
| | Color, . . .) |
| ID_value | The value of the sub-field (e.g., 0671027387, |
| | blue, . . .) |

Table III includes data fields associated with a buying experience. The data fields of Table III may store preceding and following webpage locations visited by users who visit a particular item that is eventually bought, returned or abandoned, for example.

TABLE III

| Field | Description |
|---|---|
| Impression_id | A unique ID for the particular impression |
| | activity |
| Timestamp_start | Start time of the impression |
| Timestamp_end | End time of the impression |
| Page_URI | URI of the current page |
| Referring_page_int | URI of referring landing page within the |
| | marketplace |
| Referring_page_ext | URI of referring landing page external to |
| | the marketplace |

Table IV includes data fields associated with field values. The data fields are non-hierarchical and buyers and sellers are identified by a unique code (User_id). The data fields define typical properties that are required to ship and account for a marketplace transaction.

TABLE IV

| Field | Description |
|---|---|
| User_id | Marketplace defined unique id of the buyer or seller |
| User_type | Buyer (B) or Seller (S) type of user |
| Username | Marketplace defined username of the Buyer |
| Bill_address | Billing address |
| Bill_city | Billing city |
| Bill_region | Billing county, prefecture, or other sub-state region |
| Bill_state_id | Numeric identifier for a state, province, or territory |
| | within a country |
| Bill_cntry_id | Numeric identifier for a country |
| Bill_pstl_code | User's postal code or zip code |
| Ship_address | Source or destination address for seller or buyer, |
| | respectively |
| Ship_city | Source or destination city |
| Ship_region | County, prefecture, or other sub-state region |
| Ship_state_id | Numeric identifier for a state, province, or territory |
| | within a country |
| Ship_cntry_id | Numeric identifier for a country |
| Ship_pstl_code | Source or destination postal code or zip code |
| First_name | First name of the person buying |
| Middle_names | Middle name(s) of the person buying |
| Last_name | Last name of the person buying |
| Company_name | Company name of the person buying |
| User_type | Whether the user transaction is for personal (P) use |
| | or an institution (I) |
| Date_of_birth | Birthdate of the user |
| Gender | Gender: M, F, U (unspecified) |
| Email | User contact e-mail |
| Phone | User contact phone number |
| Webpage | User contact webpage |
| Feedback_pct | Positive acceptance rating of the user (e.g., 99.95% |
| | merchant approval rating) |
| Feedback_amt | Number of customer feedback scores for the user |
| | (e.g., 4472 feedback scores) |
| Feedback_rating | Rating code for the user's rating level within the |
| | marketplace |
| Feedback_status | Status level for the user within the marketplace |

Table V includes data fields associated with meta data. This data representation may be stored by a third party, such as a country's national weather service, a news service, a government agency, an online social networking service or an online information sharing service, for example. The meta data may be aggregated with a marketplace's Ecommerce transactional data to the benefit of the marketplace. A marketplace may use weather data, as shown in Table V in order to perform inventory adjustments. For example, additional snow shovels may be placed for sale, or prices increased, during dates having historically high chances of snowfall.

TABLE V

| Field | Description |
|---|---|
| Timestamp | Universal Timestamp of weather update |
| City_id | Numeric identifier for a city, town, village, etc. |
| State_id | Numeric identifier for a state, province, or territory |
| | within a country |
| Country_id | Numeric identifier for a country |
| Temperature | Temperature (e.g., 20° C., 80° F., . . .) |
| Precipitation | Precipitation within the last 24 hours (e.g., 10 mm, |
| | 1 in, . . .) |
| Wind | Windspeed (incl. direction) (e.g., W 10 km/h, SE |
| | 20 mph, . . .) |

Data analytics describe what has happened and what may happen to items within online marketplaces. Data analytics may be provided to marketplaces in a wide variety of formats and levels of sophistication including standardized reports, ad hoc reports, queries, alerts, statistical analyses, forecasts, predictive models, and optimizations. Computer dashboard representations enable marketplaces to directly observe and interact with data analytics to generate insights whereas Application Programming Interfaces (API) representations are more likely to be processed by computing systems that leverage analytics to generate automated actionable insights.

Data may be transferred to and from marketplaces as a variety of analytics based on raw data and meta data. Analytics range from organized presentations of raw data to optimized recommendations. Raw data examples include price, item identifier, and quantity values. Statistic examples include average price and top 10 selling items in an Ecommerce category. Report examples include a trend line graph of prices over time and charts comparing seasonality versus quantities of items sold. An alert example includes a message that is sent to interested merchants once average item selling prices are greater than a particular margin. A forecasting example includes estimating how the price or quantity for a basket of items will change in the future. A prediction example includes an estimate that a merchant has a 90% chance of selling an item for a 30% greater margin if the merchant is prepared to keep the item posted for sale an extra 7 days. An optimization example includes automated changes to an item's price in a geographical region in response to a measured change in supply and demand for that item over the last 24 hours.

Data may be shared between marketplaces based on the example data representations shown in Tables I-V. Alternatively, individual data fields or combinations of data fields may be shared. As will be described, the data that may be received from the data storage and analysis system 102 is determined by the data that is sent to the data storage and analysis system 102.

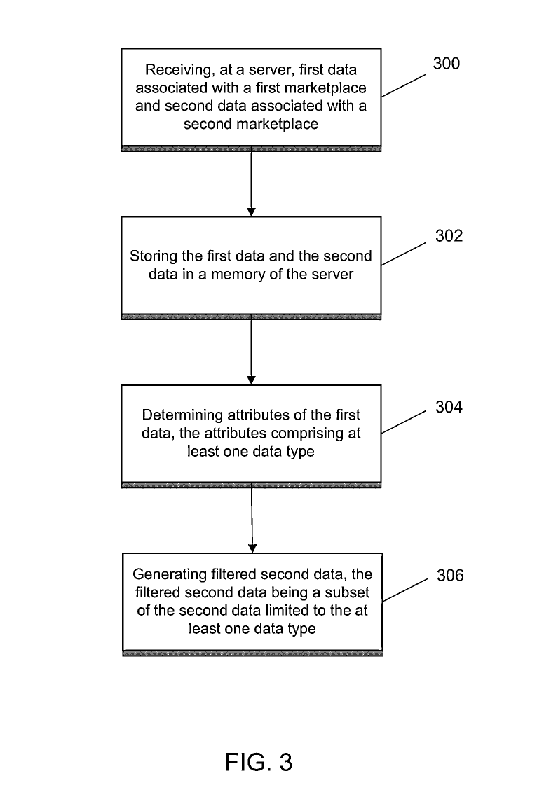

A flow chart illustrating a method of sharing data is shown in FIG. 3. The steps of FIG. 3 may be carried out by routines or subroutines of software stored in the memory of the server of the data storage and analysis system 102 and executed by, for example, the processor of the data storage and analysis system 102. Coding of software for carrying out such steps is well within the scope of a person of ordinary skill in the art given the present description.

First data, which is associated with a first marketplace 100, and second data, which is associated with a second marketplace 100 are received, at 300, at a server of the data storage and analysis system 102. The first data and the second data are then stored, at 302, in the structured data storage 204 at the server and attributes of the first data are determined using a recommendation system, at 304. The attributes of the first data include at least one data type. The data type may be one or more data fields or a data representation including more than one data field. Filtered second data is then generated, at 306. The filtered second data is a subset of the second data and is limited to the at least one data type.

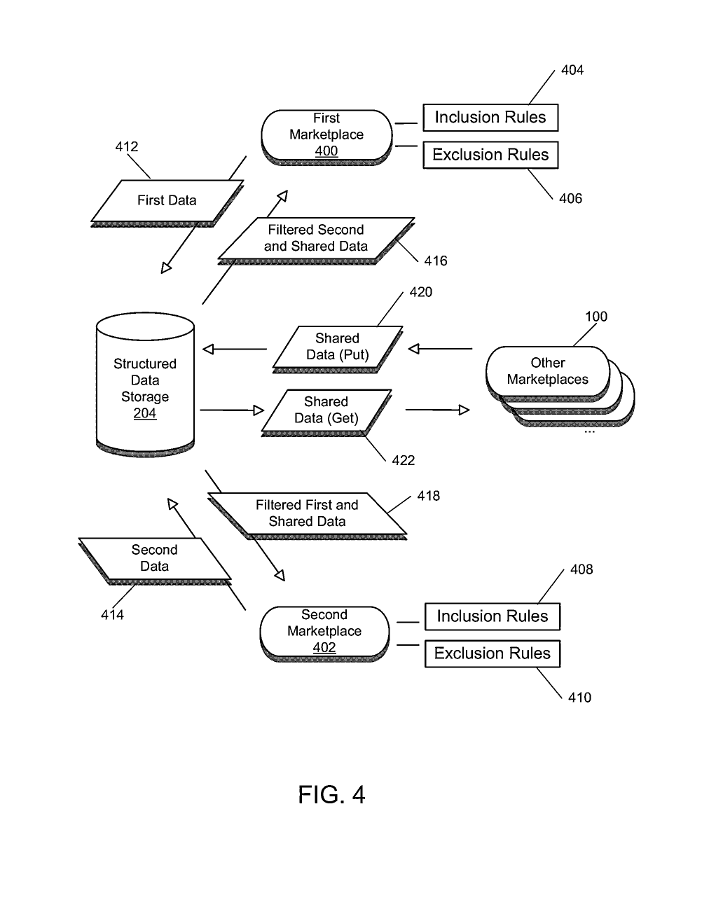

Continued reference is made to FIG. 3 with additional reference to FIG. 4 to describe one example of a method of sharing data. In the present example, the server receives, at 300, first data 412 from a first marketplace 400, which includes one category of goods and excludes five categories of goods, and stores, at 302, the first data 412 at the server. The server also receives, at 300, second data 414 from a second marketplace 402, which includes five categories of goods and excludes one category of goods, and stores, at 302, the second data 414 at the server. A data field or data representation associated with the one category of goods of the first data is then determined, at 304. Filtered data 416, which is a subset of the second data 414 that matches the data field or data representation determined in 304, is then generated 306.

As shown, the first data that is shared is determined based on inclusion rules 404 and exclusion rules 406, which are specific to the first marketplace 400. Similarly, the second data that is shared is determined based on inclusion rules 408 and exclusion rules 410, which as specific to the second marketplace 402. One or both of the inclusion rules and the exclusion rules may be the same for the first marketplace 400 and the second marketplace 402.

Similar to the first marketplace 400, the second marketplace 402 may receive filtered data 418 from the data storage and analysis system 102. The filtered data 418 is a subset of the first data 412 that matches a data field or data representation determined according to the five categories of goods shared by the second marketplace 402.

Referring still to FIG. 4, when multiple marketplaces 100 participate according to the data sharing method, shared data (put) 420 is received 300 by the server and stored 302. A data field or a data representation of the shared data 420 is determined for each marketplace 100, at 304, and shared data (get) 422 is generated, at 306, and sent to the respective marketplaces 100. As will be understood by a person skilled in the art, each of the marketplaces 100 will have their own inclusion and exclusion rules, which determine the filtered data content.

Because of the large volume of Ecommerce transactional data associated with a marketplace 100, configurations and permissions take the form of rules for sharing data. In addition, because each marketplace may include different data storage structures, field names, languages and currencies, for example, rules for mapping data fields of marketplaces to a common data structure are also provided. The common data structure defines data fields and values that correspond to data uploaded or downloaded by a participating marketplace or third party. The rules for mapping marketplace-specific data to the common structure may account for one-to-many relationships where a conceptually similar good or service is assigned multiple unique model numbers, translation differences between natural languages and other inconsistencies between marketplaces and the common data structure.

The following examples illustrate use of the common data structure when translating between marketplaces having different data structures.

In one example, prices listed on one marketplace are specified in [symbol] and prices listed on another marketplace are specified in US $. To achieve the common data structure, non-US currencies are converted into US $ and the conversion rate that was used to convert from the non-US currency, such as [symbol] or ¥, into US $ is stored.

In another example, a shipping location field for one geographical region is mapped to the most conceptually similar geographical region during data aggregation. A unique token “t989” may be used to represent the conceptual geographical region that is one level below a country, such as a “State” within a US marketplace. When this marketplace supports trade with Canada, the same “t989” token could represent “Province”. When the US marketplace, Marketplace A, shares its data with a Japanese marketplace, Marketplace B. The field “Region” (in English) and “ [symbol] ” (in Japanese Kanji) would both also map to the token “t989” to facilitate data sharing and aggregation rules between these two marketplaces and three countries. When Marketplace A shares “Ohio” state shipping data, Marketplace A would be able to access commensurate “Kyushu” region (“ [symbol] ” [symbol] ) shipping data from Marketplace B.

In another example, unique item identifiers for marketplaces are mapped to and from a generalized unique identifier. A unique Yahoo! Japan product ID (YPID) may map to a provider's generalized identification number, such as a Data Service Provider ID (DSPID), to enable comparisons with other marketplace item identifications, such as an eBay product ID (EPID). Some marketplaces may specify unique identifiers for different levels of item granularity. For example, differently colored items on one marketplace may have the same unique identifier on one marketplace but a different identifier for each color on another marketplace. Such item identification conflicts will result in one-to-many and many-to-one relationships between a marketplace ID and a generalized provider ID. In general, these many-to-one and one-to-many conflicts may occur for any shared field. Sharing ambiguities arising from these conflicts are minimized by defining sharing rules according to the generalized provider's data representation instead of each marketplace's data.

In one embodiment, an asymmetric data sharing arrangement is provided between one or more marketplaces. In this embodiment, compensation, such as points or money, for example, may be provided as one of the attributes in order to obtain different volumes and/or qualities of data.

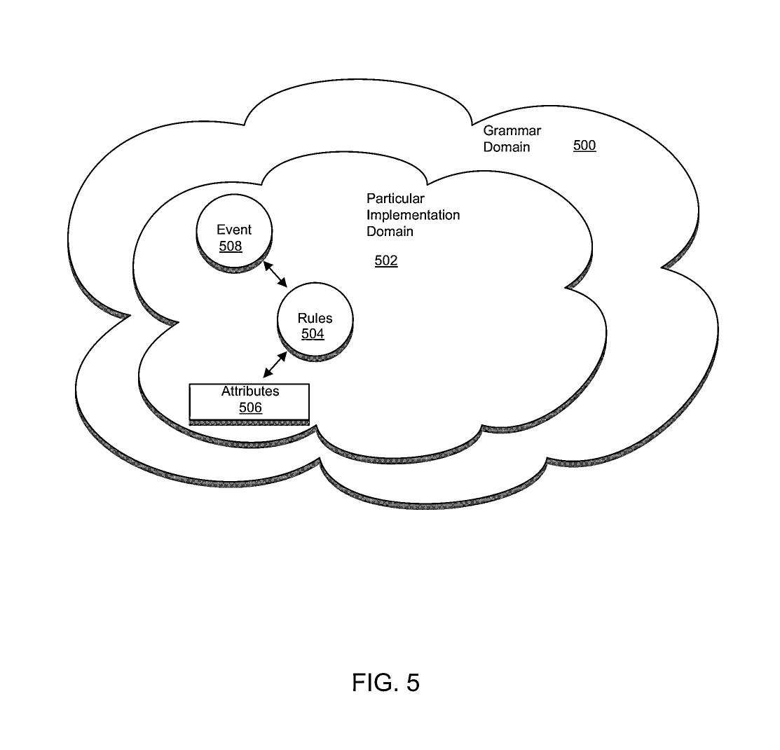

Referring to FIG. 5, sharing rules for marketplace data may be based on any formal grammar 500 including rules for transforming strings that may express formal language representations of Ecommerce data. Sharing rules for some embodiments span a smaller domain 502 due to practical limitations such as incomplete access to all possible data, time constraints developing computer code, unlikely usage or profit by users, and business licensing restrictions. In one embodiment, sharing rules 504 that operate on one or more attributes 506 are provided. Attributes 506 may include a data type, such as entities stored as independent data fields within data representations, for example, a data value, a marketplace size, which may be based on revenue or number of items bought or sold per year, a marketplace location or other marketplace properties and other data.

In one example, a marketplace includes an item hierarchy with a level one tier of “Clothing, Shoes & Accessories”, a level two tier of “Women's Shoes”, and a level three tier of “Athletic”, “Boots”, “Flats”, “Heels”, and “Other”. An example sharing rule defined by rules 504 may share all objects within the level two tier “Women's Shoes”. Example attributes 506 to be shared may include field types (e.g., city, model number, color, . . . ) and values (e.g., New York, 12UP899, black, . . . ). Example marketplace attributes include {marketplaces with revenue <$50 M/yr}, {[items with unit price >$5.00] & [state==“New York”]}. Events 508 may modify the data sharing rules specified with structures 504, attributes 506, and expressions 508. For example, data for sharing may be added or removed when a sales target event or a date event occurs. Alternatively, sharing of more detailed summer clothing data may be triggered during winter off-season months. Some embodiments may include complex event mechanisms such as machine learning engines that operate over the rules 504 and attributes 506.

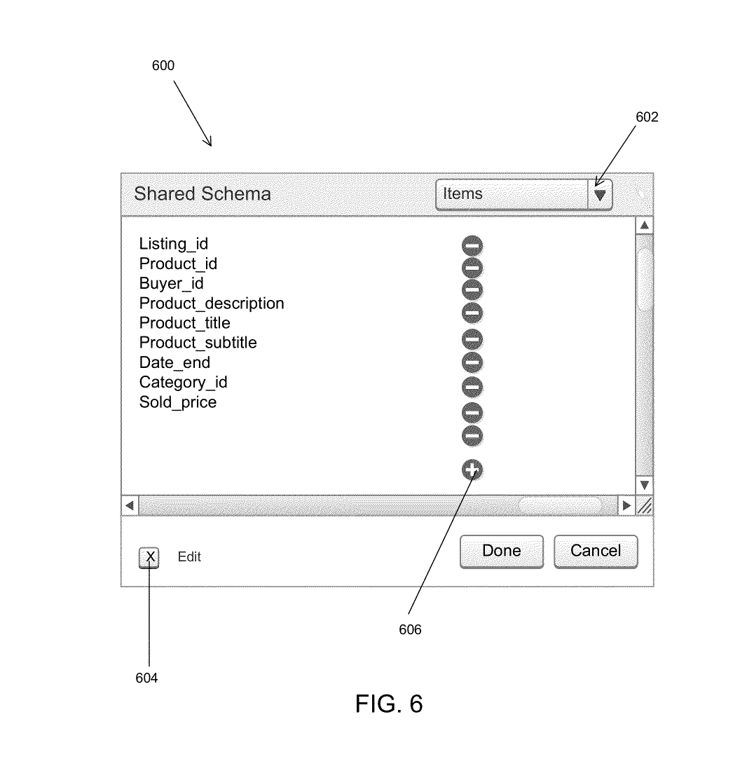

Referring to FIG. 6, a user interface 600 for indicating data to be shared is shown. A drop down menu 602 includes data representations of Ecommerce transactional data, such as the data representations of Tables I-V. The user interface acts as a visualization of shared data. The data may be set to unmodifiable by disabling an edit option 604. A marketplace may wish for some users to view which of its data are shared with other marketplaces without giving modification access to some internal or external users. Such user access control may be implemented using access control systems that are well known in the art, such as a username and password that enables or disables particular user interface functionality. Users with permission to edit a marketplace's shared data representations are able to add or remove data representation fields that are shared with other marketplaces. For example, a user could select the add option 606 and then populate a “Date_start” field to begin sharing start timestamps of an item for sale. When using the data representation of Table I, “Date_start” data may stored for a particular marketplace.

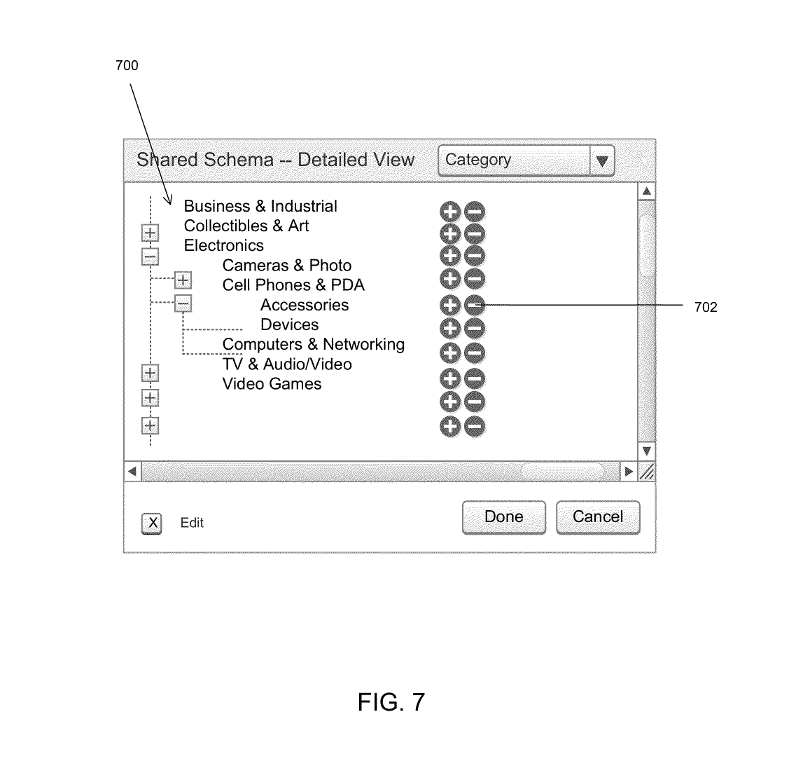

Referring to FIG. 7, a list of shared fields 700 is shown. Data fields may be removed from sharing by selecting a remove option 702 located beside the data field to be removed. In general, adding or removing data to or from, respectively, the list of shared data will only affect data sharing from the time when the operation is performed in the user interface. Consequently, once data is removed from sharing by a marketplace, other marketplaces that previously accessed shared data will still be permitted to use the data shared up until the time the marketplace removed sharing of the data field in the user interface. Similarly, once data is added to sharing by a marketplace, other marketplaces will have access to shared data from the time the operation is performed in the user interface, but not before.

The shared fields of FIG. 7 are associated with a “Category” data representation, as shown. The hierarchy in FIG. 7 enables a marketplace to share some field values, but not others. To remove cell phone and PDA accessories, a user may select the remove option 702 next to “Accessories” in FIG. 7. This would allow the marketplace to share and access cell phone and PDA “Devices” with and from, respectively, other marketplaces. Similarly, to activate “Accessories” sharing, a marketplace may select the add option 606 next to the “Cell Phone & PDA” field and select “Accessories”. Although FIG. 7 shows a hierarchical tree of detailed field data, other embodiments may specify sub-field sharing based on keywords or other mechanisms. A keyword approach, instead of a hierarchical tree, is useful to allow a marketplace to restrict sharing of product item text with particular keywords. In addition to being specification interfaces, the user interfaces of FIG. 6 and FIG. 7 serve as visualizations where a marketplace may view what sharing rules are currently active for another marketplace.

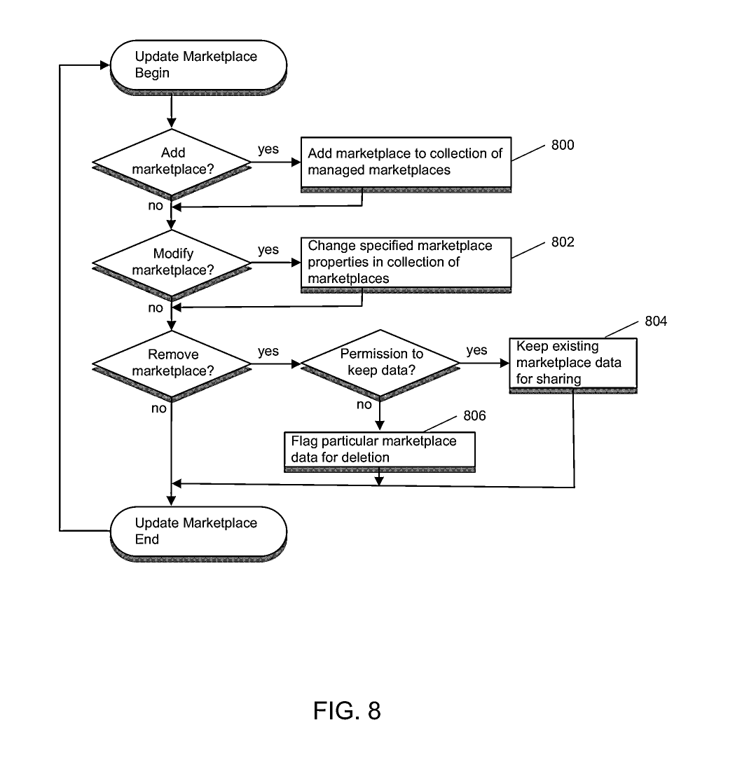

Marketplaces may be added, modified or removed from the data storage and analysis system 102, as shown in FIG. 8. A new marketplace 100 may be added to a collection of marketplaces that participate in data sharing, at 800. When a marketplace is a participant of the data storage and analysis system 102, properties relating to the marketplace may be modified, at 802. Modifications 802 may include any changes to the marketplace's Ecommerce data sharing rules 504, attributes 506, and events 508. In one example, the categories of data to be shared by a marketplace chooses may be modified. A marketplace that is a participant of the data storage and analysis system 102 may also be removed. Existing data may be maintained, at 804, in the data storage and analysis system 102 or existing data may be deleted, at 806, therefrom, depending on the sharing permissions established with the marketplace data to be removed.

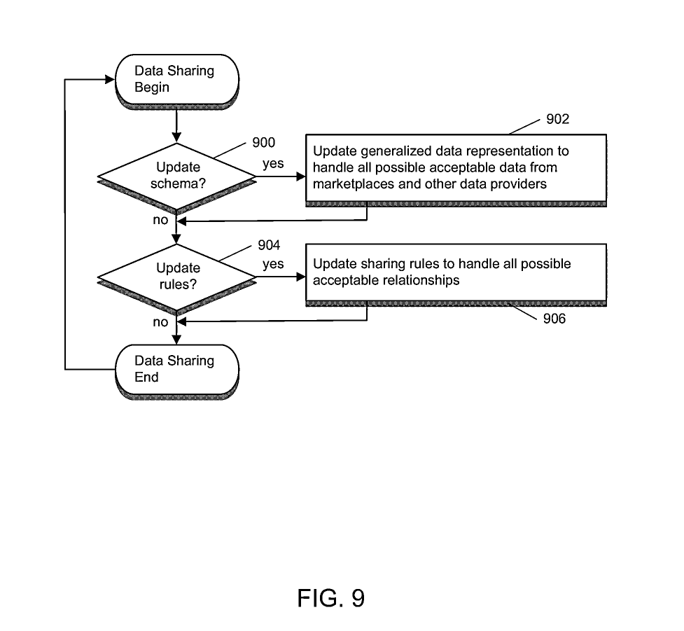

In addition, rules for sharing data, rules for mapping data fields of marketplaces to a common data structure and the common data structure may be modified. When a marketplace begins selling a new category of items, such as clothing, for example, data sharing rules relating to clothing would need to be added. As shown in FIG. 9, the server determines if the common data structure is to be updated at 900. When the common data structure is to be updated, the update is performed, at 902. When the common data structure is not to be updated, the server determines if sharing rules are to be updated, at 904. When sharing rules are to be updated, all possible acceptable relationships between data shared by marketplaces are updated, at 906.

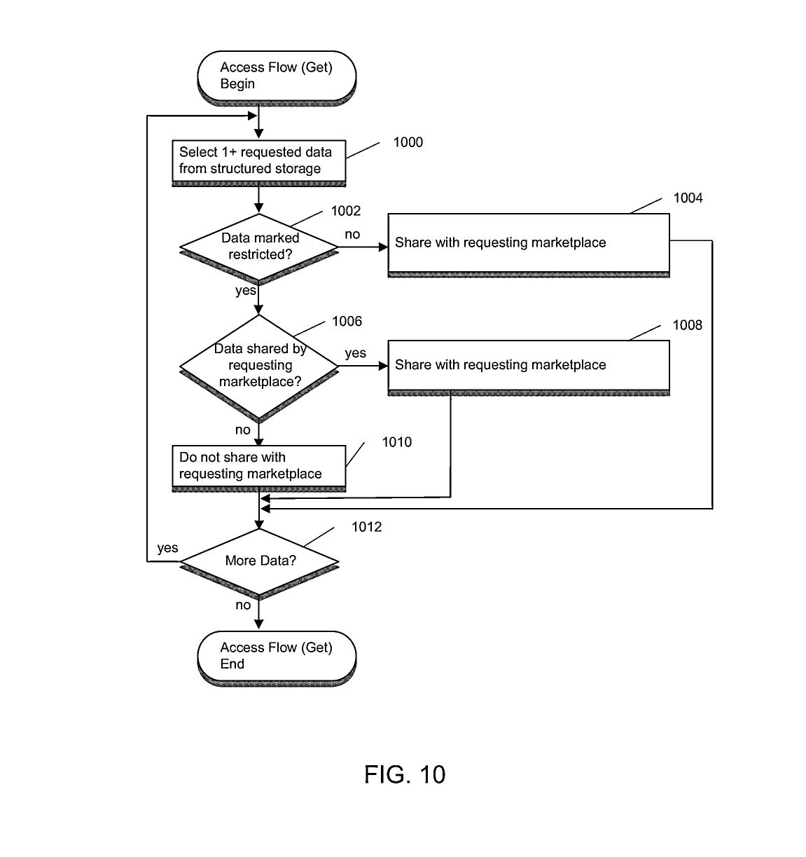

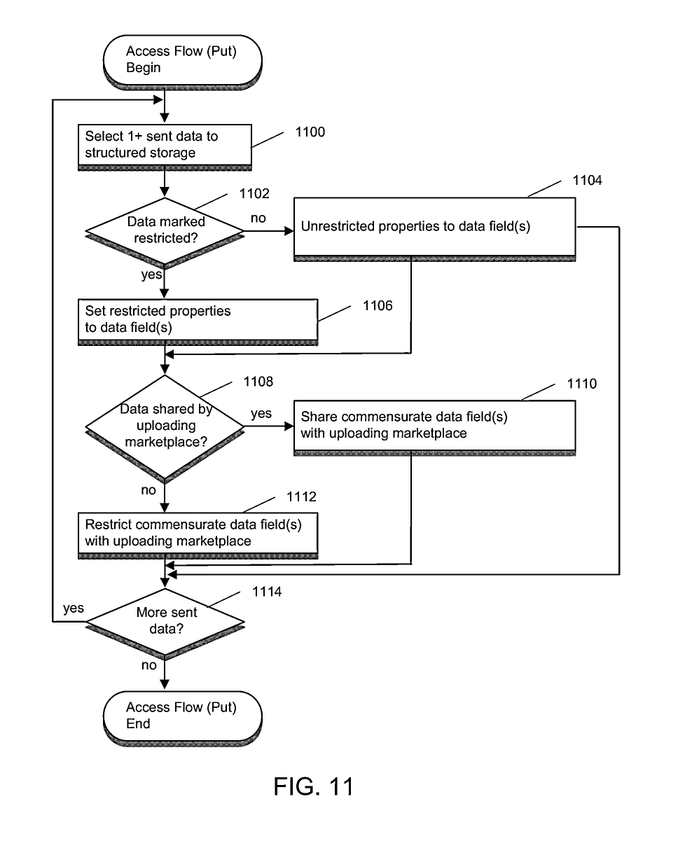

FIGS. 10 and 11 show example methods for handling data transfers between structured data storage and marketplace servers, which may be used when performing the method of FIG. 3. FIG. 10 shows requested data by a marketplace and FIG. 11 shows sent data to a marketplace.

Referring to FIG. 10, a method of requesting data from structured data storage 204 is shown. At 1000, a data request is received by the server of the data storage and analysis system 102. The server then determines if the data is marked as restricted, at 1002. Data is typically marked with values associated with the origin of the data and sharing status. Examples of unrestricted data include metadata, such as historical weather data, model numbers & descriptions of goods, for example. A marketplace 100 may mark any of its data fields as unrestricted. When the data is marked as unrestricted, the data may be shared with the requesting marketplace 100, at 1004. When the data is marked as restricted, the server determines if the data that has been requested by the requesting marketplace 100 was previously or will be shared by the requesting marketplace 100, at 1006. When the requested data has been or will be shared by the requesting marketplace 100, the requested data, which may be filtered data when the requested data is a portion of the total data uploaded from the marketplace 100, is sent to the requesting marketplace, at 1008. When the requested data has not been or will not be shared by the requesting marketplace 100, the requested data is not sent to the requesting marketplace 100, at 1010. The method may then be repeated, at 1012, on further data.

Referring to FIG. 11, a method of putting data to structured data storage 204 is shown. At 1100, a data update is received from a marketplace by the server of the data storage and analysis system 102. The server then determines if the data is marked as restricted, at 1102. Data is typically marked with values associated with the origin of the data and sharing status. Examples of unrestricted data include metadata, such as historical weather data, model numbers & descriptions of goods, for example. A marketplace 100 may mark any of its data fields as unrestricted. When the data is marked as unrestricted, unrestricted data properties are set for the marketplace 100, at 1104. When the data fields are restricted, the data is governed by sharing rules and restricted data properties are set for the marketplace 100, at 1110. When the data is marked as restricted, the server determines if the data that has been put by the marketplace 100 was previously or will be shared by the marketplace 100, at 1008. When the put data has been or will be shared by the marketplace 100, the put data is sent to the uploading marketplace, at 1110. When the put data has not been or will not be shared by the marketplace 100, properties commensurate data of other marketplaces will be marked as not sharable, at 1112. The method may then be repeated, at 1114, on further data.

The sharing methods described in the present application rely on a common data structure being applied to all marketplaces 100, rules for mapping marketplace-specific data to the common data structure and rules for sharing data that may be customized by each marketplace 100.

Using the sharing methods described herein, it is possible to resolve differences in quality and/or volume of data transferred between the providing and receiving marketplaces. Surplus and deficit data asymmetries may be reduced by placing data transfer thresholds on either outgoing or incoming data between two or more marketplaces. Alternatively, surpluses or deficits may be resolved by the marketplace requesting surplus data paying compensation such as currency or points to one or more deficit marketplace(s) and data service provider(s). Data value is derived as a function of the type, quality, and volume of data. Examples of data quality and volume are described below.

In one example, for commensurate types of online Ecommerce listing data, Marketplace A has a 50% higher online auction listing success rate for its merchants compared to Marketplace B. Success rate differences can arise from numerous sources such as different listing fees between marketplaces or online customer demographics. In this example, one unit of the same type of data from Marketplace A could be deemed more valuable than Marketplace B according to a valuation function that includes listing success rate.

In another example, for commensurate types of online Ecommerce listing data, Marketplace A offers 10 million items per day to its users whereas Marketplace B offers 1000 items per day to its users. In this example, one unit of aggregated data from Marketplace A could be deemed more valuable than a commensurate type of data from Marketplace B according to a valuation function that includes volume of listings.

An example valuation function manages value exchange balancing with a decision tree that specifies valuations and restrictions based on data quality and data volume for one or more marketplaces participating in data sharing. The results of this valuation function may change the decision, at 1006 of FIG. 10, to declare data as commensurate with requested data from one or more other marketplaces. Value exchange decisions based on artificial intelligence techniques other than decision trees may also be used.

In one example of value exchange balancing, Marketplace X and Marketplace Y share data. A data storage provider sets a compensation point to be worth US $0.0001 for data shared between Marketplace X, Marketplace Y, and the data service provider. The valuation function initially deems each marketplace's data to have no valuation balancing restrictions. The valuation function supports adding, modifying, and removing balancing rules that influence valuation decisions by Marketplace X, Marketplace Y, and independent mediators, such as the data service provider or a crowdsourced decision system. Marketplace X may be a leading online collectibles merchant with 100 million data field values and Marketplace Y may be 1 million commensurate data field values. Marketplace X may add a volume rule whereby Marketplace Y may only receive as many data values as it shares with Marketplace X (i.e., 1 million values); additional data values shall only be shared at a rate of 1 compensation point per value. Marketplace Y may then define a quality rule whereby the worth of each of its data values is calculated by the higher of (i) the ratio of Marketplace Y's sales success rate:Marketplace X's sales success rate, or (ii) a ratio of 1:1. When Marketplace X and Marketplace Y have sales success rates of 10% and 20%, respectively, each data value of Marketplace Y would be equivalent to two data commensurate data values of Marketplace X. Combining with the quantity rule above, Marketplace X may share 2 million values with Marketplace Y instead of 1 million values without Marketplace Y paying additional compensation. When the data service provider, an independent mediator, becomes aware of the unfairness of the 1:1 ratio quality threshold set by Marketplace Y, the data service provider may modify the quality rule such that data values between Marketplace Y and Marketplace X are calculated based on Marketplace Y's sales success rate:Marketplace X's sales success rate, regardless of which marketplace has a higher success rate. Marketplace Y may receive a total of 4 million commensurate data values of Marketplace X data from the data service provider over a reporting period of one year. Marketplace Y may then be required to pay US $200 to Marketplace X (i.e., $200=[4 million data values−[1 million data values offered for sharing*2:1 value quality ratio]]*1 point/value*$0.0001/point).

The data sharing method described herein is implemented based on an agreement between marketplaces embodied as sharing rules. In one example, the method of sharing data described herein may be implemented as follows.

We first define our universe of discourse U⊂N where N equals a natural number {0, 1, 2, . . . } such that U is a finite set of natural numbers that map data fields, both data and meta data, of relevance to Ecommerce transactions. Each natural number in U has a 1:1 symmetric relationship and conceptually maps to an Ecommerce data field. Each number in U is a unique identifier to a particular data field such as price, quantity, item number, item description, and purchase time.

Next, we declare inclusion and exclusion sharing rules. Let i=0, 1, . . . , nᵣᵢ where nᵣᵢ equals the number of inclusion sharing rules in use by all marketplaces. Similarly, let j=0, 1, . . . , nᵣⱼ where nᵣⱼ equals the number of exclusion sharing rules in use by all marketplaces. In one embodiment, i and j are keys for inclusion and exclusion mappings, respectively, that map to value tuples of data fields.

All possible inclusion and exclusion data sharing rules in use by a data sharing system can be defined as follows. Let Aᵢ⊂U ∀ i create nᵣᵢ sets of data fields for inclusion, and let Aⱼ⊂U ∀ j create nᵣⱼ sets of data fields for exclusion, respectively. nᵣᵢ and nᵣⱼ mappings for inclusion and exclusion sharing rules can be defined by mapping functions Fᵢ:U→Aᵢ and Gⱼ:U→Aⱼ, respectively. Fᵢ is one of Nᵣᵢ mappings that define a collection of inclusion data fields. Similarly, Gᵢⱼ is one of Nᵣⱼ mappings that define a collection of exclusion data fields. Mappings F and G may include meta mappings to define that two or more data fields are to be treated as the same for some marketplaces, and vice-versa. This implementation of F and G mappings also accommodate asymmetric data sharing where one marketplace may share or receive some data fields from other marketplaces even if the said marketplace will not receive or share commensurate data fields, respectively. Reasons for asymmetric data sharing include (i) political legislation or legal licenses that prohibit sharing of data with particular entities or regions to protect user privacy or sensitive item technology, and (ii) the value of data elements defined by a data field for one marketplace is significantly different than one or more other marketplaces.

Each marketplace has collections of sharing mappings F and G. Let k=0, . . . , nₘₖₜ where nₘₖₜ equals the number of marketplaces participating in the data sharing system. Let mₖᵢ⊂i ∀ k where mₖᵢ equals the inclusion sharing rules currently defined for each marketplace, and let mₖⱼ⊂j ∀ k where mₖⱼ equals the exclusion sharing rules currently defined for each marketplace.

The following determines what data a marketplace may receive. For all nₘₖₜ marketplaces, there exists a subset of inclusion data fields, p, and exclusion data fields, q, such that H holds, where H defines the data fields available to the said marketplace. An example of H is the resulting data fields from all marketplaces sharing the same inclusion mappings, F, and the exclusion mappings, G, as the marketplace of interest. In other words, (∀ nₘₖₜ)(∃ r) {rεU:H(p,q)} where an example of H is H(r)=(u_{pεmai} Fₚ)∩ [symbol] (u_{qεmaj} G_{q}). More generally, one needs a conflict resolution mechanism to resolve the collection of inclusion and exclusion sharing rules associated with each marketplace. We can define AεU, where A are the resultant set of data fields from application of rules for a marketplace. It follows that {xεU:C(x)} denotes the set of all x that are already members of A such that the conflict resolution C holds; if a conflict occurs between a rule that permits sharing and a rule that restricts sharing, C can ensure the restricting rule takes precedence. One possibility for C is H=F∩ [symbol] G.

A set of data instances defined by a data field may be better represented as two or more data fields, or vice-versa, depending on the context in which the data fields are used. This fuzziness in data field rule definition can be accomplished by allowing overlap of data elements represented by each unique data field in U. For example, a price data field may contain different taxes and currency exchange components that one may wish to treat as one or many separate data fields depending on the context of the data shared between marketplaces. Different contextual interpretations of data fields can thereby be handled by creating multiple mappings F and G that operate over the same data elements assigned to each marketplace.

One or more advantages may be realized by the apparatus and methods of the present disclosure. Traditional access administration methods often hinder propagation of data and insights in ways that stifle innovation and growth. The data sharing methods described herein motivate marketplaces 100 to grant increasing access to their Ecommerce transactional data in exchange for increasing access to the Ecommerce transactional data of other marketplaces.

The above-described embodiments are intended to be examples only. Alterations, modifications and variations can be effected to the particular embodiments by those of skill in the art without departing from the scope of the present application, which is defined solely by the claims appended hereto.

What is claimed is:

1. A method of sharing data, comprising:
receiving, at a server, first data associated with a first marketplace and second data associated with a second marketplace;
storing the first data and the second data in a memory of the server;
determining attributes of the first data, the attributes comprising at least one data type;
generating filtered second data, the filtered second data being a subset of the second data limited to the at least one data type;
wherein the filtered second data is for sending to the first marketplace in response to the first data being received at the server.

2. A method as claimed in claim 1, wherein the second data is associated with more than one marketplace.

3. A method as claimed in claim 1, wherein the attributes comprise one of: a data value, a marketplace size and a marketplace location.

4. A method as claimed in claim 1, wherein the first data comprises at least one of: price, quantity, item number, item description, and purchase time.

5. A method as claimed in claim 1, wherein the second data comprises at least one of: price, quantity, item number, item description, and purchase time.

6. A method as claimed in claim 1, comprising receiving, at the server, other data, the other data for sending to the first marketplace.

7. A method as claimed in claim 1, wherein the at least one data type is one or more data fields.

8. A method as claimed in claim 1, wherein at least some of the first data is marked unrestricted to be shared with the second marketplace.

9. A method as claimed in claim 7, wherein the filtered data is determined based on inclusion data fields and exclusion data fields set by the first marketplace.

10. A method as claimed in claim 3, wherein the data value is a function of data quality and volume of data.

11. A method as claimed in claim 1, wherein the filtered second data comprises second data of a type other than the at least one data type when the attributes comprise compensation.

12. A method as claimed in claim 1, wherein data associated with the first marketplace comprises an indication of the data type when received at the server.

13. A method as claimed in claim 1, comprising sending the filtered second data to the first marketplace in response to a request from the first marketplace.

14. A method as claimed in claim 1, wherein when the filtered second data is generated, a valuation function is used to compensate for imbalances between data volume of the first data and the second data.

15. A method as claimed in claim 1, wherein when the filtered second data is generated, a valuation function is used to compensate for imbalances between data quality of the first data and the second data.

16. A non-transitory computer-readable medium comprising instructions executable on a processor of the server for implementing the method of claim 1.

17. A system of sharing data, comprising:
a first online marketplace;
a second online marketplace; and
a data and analysis system comprising a server receiving first data from the first online marketplace and second data from the second online marketplace, determining attributes of the first data, the attributes comprising at least one data type and generating filtered second data, the filtered second data being a subset of the second data limited to the at least one data type, and sending the filtered second data to the first online marketplace in response to the first data being received at the server.
